(19) United States
(12) Patent Application Publication
(10) Pub. No.: US 2025/0371613 A1
(43) Pub. Date: Dec. 4, 2025

(54) INTELLIGENT PROCESSING OF MORTGAGE LOAN APPLICATIONS USING A VIRTUAL PROCESSOR

(71) Applicant: Stephen Kobelski, Bozrah, CT (US)

(72) Inventor: Stephen Kobelski, Bozrah, CT (US)

(21) Appl. No.: 18/678,635

(22) Filed: May 30, 2024

(51) Int. Cl. G06Q 40/03

(52) U.S. Cl. CPC G06Q 40/03

(57) ABSTRACT

Systems and methods provide for the intelligent processing of mortgage loan applications using a virtual processor. In one embodiment, the system receives a set of non-standardized input data including information required by one or more lenders associated with a user who is a mortgage broker, applicant, or correspondent lender; catalogs one or more requirements of each lender based on the input data; standardizes the input data into a standardized format; receives preliminary information from the user and processes it to determine additional requirements of the lender; assigns one or more tasks to the user based on the requirements; receives, in response to the assignments, information related to the user; generates, using at least the information related to the user, output documents in specific formats required by the one or more selected lenders using the standardized input data; and facilitates the e-signature of the generated output documents by the user.

### TECHNICAL FIELD

Implementations relate generally to mortgage lending. More specifically, implementations relate to methods and systems for the intelligent processing of mortgage loan applications using a virtual processor.

### BACKGROUND

The mortgage lending industry can be characterized by a high degree of fragmentation and variability. Each lender has its own unique set of requirements, forms, and processes that must be adhered to in order to secure a mortgage loan. This includes tasks which must be completed by a mortgage broker, applicant, or correspondent lender in order to fund the loan. Not only may the tasks themselves vary from lender to lender, but the required information for each task may also vary, as well as the format of documents to be completed. This lack of standardization creates significant challenges for mortgage brokers and applicants who must navigate and comply with different sets of rules, leading to inefficiencies and increased processing times.

Traditionally, mortgage brokers working with multiple lenders need to manage multiple sets of paper-based or electronic forms, each tailored to the specific requirements of individual lenders. This often involves redundant data entry, reformatting documents, and revalidating information to meet each lender's specifications. Such processes are not only time-consuming but also prone to errors, which can further delay loan approvals and increase costs for both brokers and applicants.

The current state of the art lacks a unified approach to handling the disparate requirements of multiple lenders. Existing software solutions typically focus on the needs of a single lender, producing standardized output only for that lender. This limitation forces brokers to use multiple systems or platforms to meet the diverse demands of different lenders, resulting in a fragmented workflow. Additionally, when an applicant decides to switch lenders, the process of re-submitting information and generating new documents further compounds the inefficiencies. This fragmented approach underscores the need for a more streamlined and intelligent solution to process mortgage loan applications effectively.

### SUMMARY

The appended claims may serve as a summary of this application.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3 is a diagram illustrating an exemplary computer that may perform processing in some embodiments.

### DETAILED DESCRIPTION

In this specification, reference is made in detail to specific embodiments of the disclosure.

For clarity in explanation, the disclosure has been provided with reference to specific embodiments, however it should be understood that the disclosure is not limited to the described embodiments. On the contrary, the disclosure covers alternatives, modifications, and equivalents as may be included within its scope as defined by any patent claims. The following embodiments of the disclosure are set forth without any loss of generality to, and without imposing limitations on, the disclosure. In the following description, specific details are set forth in order to provide a thorough understanding of the present disclosure. The present disclosure may be practiced without some or all of these specific details. In addition, well known features may not have been described in detail to avoid unnecessarily obscuring the disclosure.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

In one embodiment, the system receives a set of non-standardized input data including information required by one or more lenders associated with a user who is a mortgage broker, applicant, or correspondent lender; catalogs one or more requirements of each lender based on the non-standardized input data; standardizes the received non-standardized input data into a standardized format; receives preliminary information from the user; processes the received preliminary information to determine additional requirements of the lender based on a multitude of variables derived from the preliminary information; assigns one or more tasks to the user based on the requirements of the lenders; receives, in response to assigning the one or more tasks, information related to the user; generates, using at least the information related to the user, output documents in specific formats required by the one or more selected lenders using the standardized input data; and facilitates the e-signature of the generated output documents by the user.

Further areas of applicability of the present disclosure will become apparent from the remainder of the detailed description and the claims. The detailed description and specific examples are intended for illustration only and are not intended to limit the scope of the disclosure.

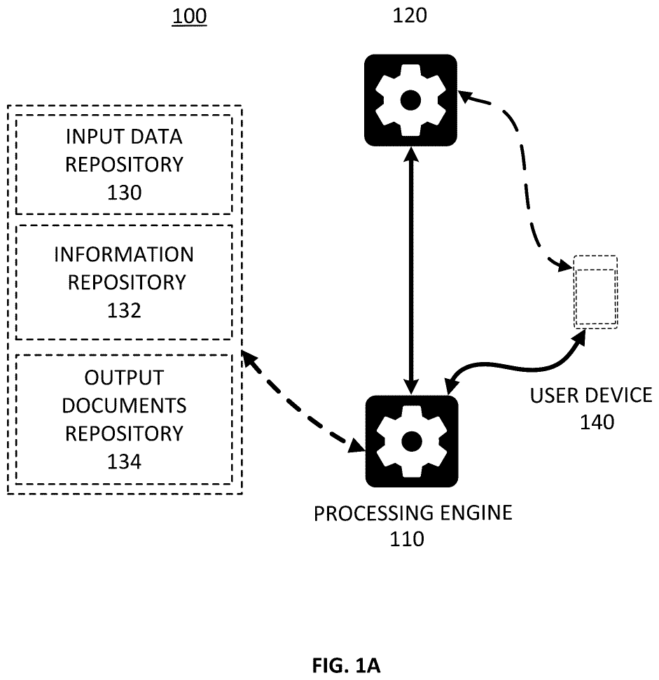

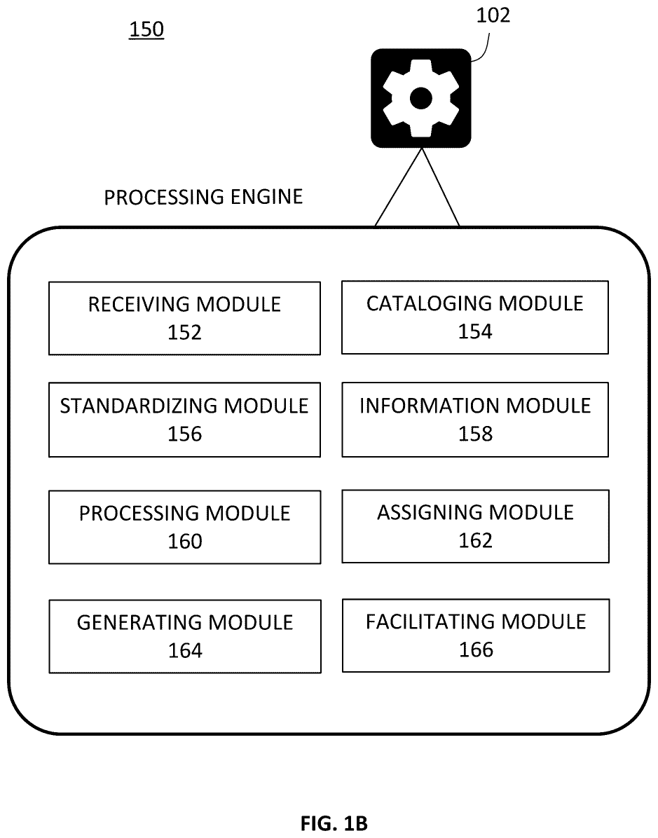

FIG. 1A is a diagram illustrating an exemplary environment in which some embodiments may operate. In the exemplary environment 100, a user device 140 is connected to a processing engine 110 and, optionally, a platform 120. The processing engine 110 is connected to the platform 120, and optionally connected to one or more repositories and/or databases, including, e.g., an input data repository 130, an information repository 132, and/or an output documents repository 134. One or more of the databases may be combined or split into multiple databases. The user device 140 in this environment may be a computer, and the platform 120 and processing engine 110 may be applications or software hosted on a computer or multiple computers which are communicatively coupled via remote server or locally.

The exemplary environment 100 is illustrated with only one user device, one processing engine, and one platform, though in practice there may be more or fewer additional user devices, processing engines, and/or platforms. In some embodiments, the user device(s), processing engine, and/or platform may be part of the same computer or device.

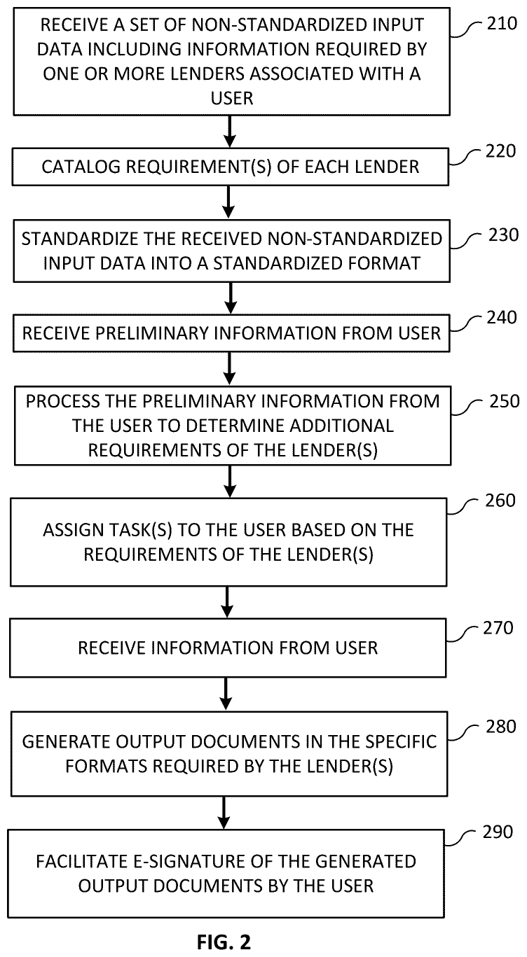

In an embodiment, the processing engine 110 may perform the exemplary method of FIG. 2 or other method herein and, as a result, provide intelligent processing of mortgage loan applications using a virtual processor. In some embodiments, this may be accomplished via communication with the user device, processing engine, platform, and/or other device(s) over a network between the device(s) and an application server or some other network server. In some embodiments, the processing engine 110 is an application, browser extension, or other piece of software hosted on a computer or similar device, or is itself a computer or similar device configured to host an application, browser extension, or other piece of software to perform some of the methods and embodiments herein.

The user device 140 is a device with a display configured to present information to a user of the device who is a user of the platform 120. In some embodiments, the user device presents information in the form of a visual UI with multiple selectable UI elements or components. In some embodiments, the user device 140 is configured to send and receive signals and/or information to the processing engine 110 and/or platform 120. In some embodiments, the user device is a computing device capable of hosting and executing one or more applications or other programs capable of sending and/or receiving information. In some embodiments, the user device may be a computer desktop or laptop, mobile phone, virtual assistant, virtual reality or augmented reality device, wearable, or any other suitable device capable of sending and receiving information. In some embodiments, the processing engine 110 and/or platform 120 may be hosted in whole or in part as an application or web service executed on the user device 140. In some embodiments, one or more of the platform 120, processing engine 110, and user device 140 may be the same device. In some embodiments, the user device 140 is associated with a first user account within a platform, and one or more additional user device(s) may be associated with additional user account(s) within the platform.

In some embodiments, optional repositories can include an input data repository 130, information repository 132, and/or output documents repository 134. The optional repositories function to store and/or maintain, respectively, non-standardized input data associated with lenders; information received from brokers or applicants; and output documents in specified formats required by lenders. The optional database(s) may also store and/or maintain any other suitable information for the processing engine 110 or platform 120 to perform elements of the methods and systems herein. In some embodiments, the optional database(s) can be queried by one or more components of system 100 (e.g., by the processing engine 110), and specific stored data in the database(s) can be retrieved.

Platform 120 is a platform configured to provide the intelligent processing of mortgage loan applications using a virtual processor, in relation to the systems and methods herein. The platform 120 may present a user, who may be a mortgage broker, applicant, or correspondent lender, with one or more user interfaces or interface components which facilitate the processing of a mortgage loan application using the virtual processor.

FIG. 1B is a diagram illustrating an exemplary computer system 140 with software modules that may execute some of the functionality described herein. In some embodiments, the modules illustrated are components of the processing engine 110.

Receiving module 152 functions to receive a set of non-standardized input data including information required by one or more lenders associated with a user, who is one of a mortgage broker, applicant, or correspondent lender. The module also functions to receive information related to the user.

Cataloging module 154 functions to catalog one or more requirements of each lender based on the non-standardized input data.

Standardizing module 156 functions to standardize the received non-standardized input data into a standardized format.

Information module 158 functions to receive preliminary information from the user.

Processing module 160 functions to process the received preliminary information to determine additional requirements of the lender based on a plurality of variables derived from the preliminary information.

Assigning module 162 functions to assign one or more tasks to the user based on the requirements of the lenders.

Generating module 164 functions to generate, using at least the information related to the user, output documents in specific formats required by the one or more selected lenders using the standardized input data.

Facilitating module 166 functions to facilitate the e-signature of the generated output documents by the user.

The above modules and their functions will be described in further detail in relation to an exemplary method below.

FIG. 2 is a flow chart illustrating an exemplary method that may be performed in some embodiments.

At step 210, the system receives a set of non-standardized input data including information required by one or more lenders associated with a user within a virtual processor platform. The user may be one of a mortgage broker, applicant, or corresponder lender associated with a user account on the platform. In the context of this method, the term “user” refers to a stakeholder involved in the mortgage loan application process who interacts with the virtual processor. These users can be broadly categorized into three main types: mortgage brokers, applicants, and correspondent lenders. A mortgage broker acts as an intermediary between borrowers (i.e., applicants) and lenders. Mortgage brokers assist applicants in finding and securing mortgage loans by comparing different loan products from various lenders. They collect necessary information from the applicant, help them complete the required documentation, and submit loan applications on their behalf. An applicant is an individual or entity seeking a mortgage loan. Applicants require financing to purchase real estate, refinance existing mortgages, or leverage their property equity for other financial needs. A correspondent lender is a type of lender that originates and funds mortgage loans but typically sells these loans to larger mortgage lenders or investors shortly after closing. Correspondent lenders manage the entire loan process, from application to funding, and maintain direct interaction with the applicant or broker during this period. They handle the underwriting, closing, and initial funding of the loan, but their primary business model involves selling the funded loans to secondary markets to mitigate risk and maintain liquidity. The virtual processor platform caters to these different users and stakeholders by providing a user interface, information, and interactivity within the platform that supports the unique needs of each category.

In various embodiments, this non-standardized input data encompasses various types of information that lenders typically require to evaluate mortgage loan applications. This can include, for example, needed personal information of the applicant, such as name, address, social security number, and contact details; financial information, including income, employment history, credit score, and existing debts; property details, such as the address, type, and value of the property being mortgaged; and specific loan details, such as the desired loan amount, interest rate, and term. In some embodiments, the non-standardized input data includes specific formatting requirements for output documents as stipulated by different lenders.

In various embodiments, lenders may be associated with a broker or applicant in various ways. In some embodiments, the applicant or broker can select which lenders they are associated with by using a drop-down box or by entering text into a text field on a user interface. This selection process allows the system to tailor the required tasks and document formats to the specific lenders chosen by the user, ensuring that the information collected is relevant and correctly formatted for the selected lenders.

In some embodiments, the system operates within a virtual processor platform that serves a multitude of users, including, e.g., brokers, applicants, correspondent lenders, or some combination of the three. In some embodiments, this platform provides a user interface catered to these users, displaying information related to the loan application process and enabling interactive entry or selection of information. In some embodiments, brokers can use the platform to, e.g., manage multiple loan applications simultaneously, track the progress of each application, and communicate with applicants and lenders. In some embodiments, applicants can access the platform to, e.g., provide required information, review loan terms, and digitally sign documents. In some embodiments, correspondent lenders can use the platform to, e.g., manage the underwriting process, ensure compliance with lender requirements, facilitate the efficient processing and funding of loans, and prepare the loans for sale in the secondary market. The user interface is designed to streamline the loan application process, providing a seamless, user-friendly experience for all parties involved and facilitating efficient communication and collaboration throughout. In some embodiments, one single platform may be utilized by both brokers, applicants, and correspondent lenders as users, with certain branding and other aspects tailored to some types of users (such as brokers) and different branding and other aspects tailored to other types (such as users).

In some embodiments, the system is designed to handle input data that arrives in various formats and structures. This non-standardized data can come from different sources, including, for example, digital forms filled out by applicants, documents uploaded by mortgage brokers, or data directly pulled from third-party systems such as, for example, credit bureaus or employment verification services. In some embodiments, the input data may include lender-specific requirements for document formats and submission protocols.

In some embodiments, upon receiving the non-standardized input data, the system employs advanced data parsing techniques to interpret and categorize the information. This can involve identifying and extracting relevant data fields from the input, even when the data is presented in an unstructured or semi-structured format. In various embodiments, the system uses one of or a combination of: rule-based algorithms, machine learning models, and natural language processing to accurately map the incoming data to a standardized schema. This process ensures that all necessary information is captured and correctly understood, regardless of the initial format in which it was received, and accommodates the specific document formatting needs of different lenders.

In some embodiments, the robustness of the data reception process is further enhanced by one or more validation mechanisms. These mechanisms check the completeness and accuracy of the received data against predefined rules and lender-specific requirements. For example, the system may verify that mandatory fields are not left blank, check for valid formats in numerical data, and cross-reference information with external databases to ensure its authenticity. In some embodiments, the system additionally ensures that the data conforms to the specific document formatting requirements of each lender. Any discrepancies or missing information are flagged for further review, and the user is promptly notified to provide the necessary corrections.

At step 220, the system catalogs one or more requirements of each lender based on the non-standardized input data. In some embodiments, this process involves analyzing the received input data to identify the specific requirements imposed by each lender participating in the mortgage loan application process. These requirements may vary significantly between lenders and encompass a wide range of criteria, including, for example, document formats, information completeness, submission deadlines, and specific data validation rules.

In some embodiments, the system utilizes advanced algorithms and data processing techniques to extract and categorize the lender-specific requirements from the non-standardized input data. In some embodiments, this involves parsing through the information provided by the lenders and identifying key criteria that must be met for each loan application to be considered complete and compliant. In some embodiments, the system may access internal databases or external sources to cross-reference the lender requirements with industry standards and regulatory guidelines. Once cataloged, the lender requirements are stored within the system's database, organized in a structured format for easy retrieval and reference during subsequent stages of the loan application process.

In some embodiments, the system stores the cataloged requirements of each lender in a centralized database accessible by the virtual processor. This database serves as a repository for storing and managing the unique requirements, preferences, and guidelines associated with each participating lender. By storing the cataloged requirements in a database, the system establishes a comprehensive and structured knowledge base that consolidates information pertinent to the mortgage loan application process. This centralized repository streamlines access to lender-specific data, eliminating the need to repeatedly gather and analyze requirements for each transaction. Mortgage brokers, applicants, and other system users can leverage this repository to quickly retrieve relevant information and streamline decision-making processes. In some embodiments, the database may incorporate features for, e.g., version control, audit logging, and/or data governance to maintain data integrity and compliance with regulatory requirements.

In some embodiments, the cataloged requirements of each lender are updated in real-time based on changes in the lenders' submission guidelines. In some embodiments, the system continuously or periodically monitors and tracks changes in the submission guidelines of each lender participating in the mortgage loan application process. This may involve, e.g., subscribing to data feeds, accessing online portals, or interfacing with APIs provided by the lenders to receive timely updates regarding any modifications or revisions to their requirements. Upon detecting changes in the lenders' submission guidelines, the system automatically updates the cataloged requirements associated with each lender. This real-time updating process ensures that the system maintains an accurate and up-to-date repository of lender-specific requirements, reflecting the latest expectations and preferences of the lenders.

At step 230, the system standardizes the received non-standardized input data into a standardized format. In some embodiments, this process involves transforming the heterogeneous data obtained from various sources and in diverse formats into a uniform structure that can be efficiently processed and analyzed by the system. In some embodiments, to achieve standardization, the system employs one or more data normalization techniques. In some embodiments, the data normalization techniques include identifying common data elements across different input formats and mapping them to a predefined schema. This schema serves as a template that defines the structure and attributes of the standardized data format, encompassing fields such as, for example, applicant information, financial details, property specifications, and loan parameters. In some embodiments, the system carefully validates and verifies each data element to ensure accuracy and completeness, correcting any inconsistencies or discrepancies encountered during the standardization process.

In some embodiments, the standardization process may involve enriching the input data by augmenting it with additional contextual information or metadata, enhancing its relevance and utility for subsequent processing steps. This enrichment may include appending, for example, timestamps, unique identifiers, or other relevant identifiers to the standardized data, facilitating traceability and auditability throughout the mortgage loan application lifecycle.

In some embodiments, once standardized, the input data is transformed into a cohesive and structured dataset that conforms to the system's internal data model. This standardized format enables efficient data manipulation, analysis, and retrieval, empowering the system to perform advanced processing tasks such as, e.g., task assignment, document generation, and compliance checks with precision and accuracy.

In some embodiments, the standardized format includes a standardized input form to collect information from the user needed for any of the one or more lenders. This standardized input form serves as a universal template designed to collect information from mortgage brokers or applicants, catering to the requirements of any of the one or more lenders involved in the mortgage loan application process. In some embodiments, the standardized input form encompasses all the essential fields and data points required by the participating lenders. It provides a structured framework for capturing various types of information, which may include, for example, personal details, financial information, property specifications, and loan preferences, among others.

At step 240, the system receives preliminary information from the user. In various embodiments, this preliminary information often originates from an initial loan request submitted by the applicant, and can include basic details about the user's loan application (or, e.g., an applicant's loan application that a broker is managing), such as the type of loan, the loan amount, and initial personal and financial information. The type of loan could range from, for example, residential mortgages to commercial real estate loans, refinancing options, or construction loans. The preliminary information may also encompass data points such as the intended use of the loan (e.g., purchase, refinance, or construction), property details, and the desired loan term.

In some embodiments, the preliminary personal information collected at this stage may include, for example, the user's or applicant's name, contact details, and identification information, such as a social security number or tax identification number. Financial information may include the user's or applicant's income, employment status, credit score, and existing debt obligations. For a mortgage broker, this information might also include their business details and licensing information. By gathering this data upfront, the system can create a comprehensive profile of the user or applicant, which can be utilized for accurately assessing loan eligibility and for providing personalized task assignments and document generation later in the process.

In some embodiments, in addition to basic personal and financial details, the system may also capture initial property-related information. This may include, for example, the property's address, estimated value, and details about the property's current ownership and condition. For a purchase loan, the system might collect information about the seller and the purchase agreement. For a refinance loan, the system might gather information about the current loan, including the loan balance and payment history.

At step 250, the system processes the received preliminary information to determine additional requirements of the lender based on a multitude of variables derived from the preliminary information. The system begins this process by analyzing the preliminary information provided by the user, which often originates from an initial loan request submitted by the applicant. In some embodiments, this preliminary data encompasses various details, such as, e.g., the type of loan sought, the requested loan amount, and initial personal and financial information of the applicant. In some embodiments, the system utilizes multi-variable analysis to dynamically and intelligently determine the specific requirements of each lender. In some embodiments, this multi-variable analysis involves evaluating a multitude of variables that are relevant to the loan application process. In various embodiments, key variables may include, for example, the property type (e.g., residential, commercial, mixed-use), the intended use of the funds (e.g., purchase, refinance, construction), the applicant's credit score, and the desired loan term length. Additionally, the system may consider other financial metrics and personal details, such as, for example, the applicant's debt-to-income ratio, employment status, and existing financial obligations. These variables often play a role in shaping the requirements that lenders will impose on the loan application.

In some embodiments, to perform this analysis, the system leverages a combination of rule-based logic and machine learning models. Rule-based logic helps to quickly filter and categorize the preliminary information based on predefined criteria set by the lenders. For instance, a lender might have specific requirements for applicants with certain credit scores or for loans of particular amounts. On the other hand, in some embodiments, machine learning models are trained on historical loan data to predict lender requirements more accurately. These models may be trained to identify patterns and correlations in the data. In some embodiments, the training of these models involves feeding them large datasets containing previous loan applications and outcomes, enabling them to learn and adapt over time.

Once the system has processed the preliminary information and evaluated the relevant variables, it generates a refined set of requirements specific to each lender involved in the application. In various embodiments, these requirements might include, for example, additional documentation, specific forms, or further verification steps that need to be completed by the applicant or broker.

At step 260, the system assigns one or more tasks to the user based on the generated set of requirements of the lenders. In some embodiments, this process involves dynamically allocating specific actions or responsibilities to the relevant parties involved in the mortgage loan application process, in order to ensure compliance with the unique requirements set forth by each participating lender.

In some embodiments, the system utilizes one or more intelligent task assignment algorithms. In various embodiments, the algorithms analyze the standardized input data, lender requirements, and predefined rules to determine the appropriate tasks to be performed by the user. These tasks may include, e.g., gathering additional documentation, providing clarifications on certain aspects of the application, conducting property inspections, or fulfilling other lender-specific requests.

In some embodiments, task assignment is tailored to the individual needs and preferences of each lender, taking into account factors such as, for example, loan type, applicant profile, and property characteristics. In some embodiments, the system prioritizes tasks based on their urgency and criticality, ensuring that essential requirements are addressed promptly based on priority to expedite the loan approval process.

In some embodiments, the system may employ machine learning techniques to continuously optimize task allocation strategies based on historical data and performance metrics. By learning from past interactions and outcomes, the system can refine its task assignment algorithms over time, further enhancing efficiency, accuracy, and user satisfaction. In some embodiments, the machine learning techniques involve the use of neural networks, which can be designed in various architectures such as, e.g., feedforward, recurrent, or convolutional neural networks, depending on the nature of the task and the characteristics of the input data. In various embodiments, these neural networks are trained on large datasets which can include, for example, historical loan application records, lender requirements, task assignments, and associated outcomes.

During the training process, the neural network learns complex patterns and relationships within the data, enabling it to make informed decisions about task assignment based on the input features and context. In some embodiments, the model may utilize supervised learning, where it is trained on labeled data with known task assignments, or reinforcement learning, where it learns through trial and error feedback based on the outcomes of its actions. As the model is exposed to more data and feedback over time, it continuously refines its task allocation strategies. In various embodiments, this may include adapting to changing lender requirements, applicant profiles, and/or market dynamics. In some embodiments, the system may incorporate mechanisms for model interpretation and explainability, allowing stakeholders such as brokers, applicants, or lenders to understand the rationale behind the model's decisions.

In some embodiments, the system dynamically updates the list of assigned tasks in response to one or more changes in the requirements of one of the lenders. In some embodiments, the system continuously or periodically monitors and evaluates changes in lender requirements, leveraging real-time data feeds or periodic updates from lenders to stay informed about any modifications or additions to their submission guidelines. Upon detecting changes, the system dynamically updates the list of assigned tasks to reflect the updated requirements, ensuring alignment with the evolving needs of the lenders.

In some embodiments, this dynamic task updating process involves evaluating the impact of the changes on the existing tasks and task priorities, as well as identifying any new tasks necessitated by the updated requirements. In various embodiments, the system employs one or more intelligent algorithms and/or decision-making logic to assess the implications of the changes and adjust the task assignment accordingly. In some embodiments, the system may prioritize task updates based on factors such as, e.g., urgency, criticality, and impact on the overall application timeline. Tasks that are directly affected by the changes in lender requirements can be promptly addressed to prevent delays or discrepancies in the application process.

At step 270, the system receives, in response to assigning the one or more tasks, information related to the user. In some embodiments, this step involves collecting updated information or documentation from the user in response to the tasks assigned to them during the previous step. The information received may include, for example, additional financial documents, property-related information, or clarifications on specific aspects of the loan application.

In some embodiments, the system provides a streamlined communication channel through which mortgage brokers and applicants can submit the required information seamlessly. This may involve leveraging digital platforms, such as, e.g., web portals or mobile applications, that enable users to upload documents, input data directly, or communicate with the system via secure messaging channels. By centralizing communication and document management, the system ensures that all relevant stakeholders have access to the latest information and updates in real-time.

In some embodiments, upon receiving the information from the user, the system performs validation checks to verify the completeness, accuracy, and relevance of the submitted data. This validation process may involve comparing the received information against, for example, predefined criteria, lender requirements, and/or regulatory standards to ensure compliance and mitigate the risk of errors or discrepancies. In some embodiments, any discrepancies or missing information are flagged for further review, and the user is notified to provide the necessary corrections or clarifications promptly.

At step 280, the system generates, using at least the information related to the user, output documents in specific formats required by the one or more selected lenders using the standardized input data. In some embodiments, this step involves dynamically creating the necessary documentation tailored to the unique formatting and content requirements of each lender involved in the mortgage loan application process.

In some embodiments, the system leverages the standardized input data, along with additional information provided by the user, to populate the required fields and sections within the output documents accurately. This may include assembling, for example, loan application forms, financial statements, property appraisal reports, and other supporting documents in compliance with the formatting guidelines prescribed by the selected lenders.

In some embodiments, in order to facilitate document generation, the system employs templating engines or document automation software that can dynamically generate documents based on predefined templates or templates customized to meet the specific needs of each lender. These templates may encapsulate, e.g., the layout, structure, and content requirements of the output documents, allowing for seamless customization and adaptation to different lender preferences.

In some embodiments, the system may incorporate intelligent data merging techniques, which enable it to merge the standardized input data with the predefined document templates. This process may involve incorporating conditional logic or dynamic placeholders within the templates to accommodate variable data elements and adapt to different scenarios. In some embodiments, once generated, the output documents undergo thorough quality assurance checks to verify completeness, accuracy, and compliance with regulatory standards and lender requirements. Any discrepancies or errors detected during this validation process are flagged for review and correction, ensuring the integrity and reliability of the documentation provided to the lenders.

At step 290, the system facilitates the e-signature of the generated output documents by the user. In some embodiments, this process involves enabling electronic signatures on the generated documentation, allowing for legally binding endorsement by the relevant parties. In some embodiments, the system provides a secure, user-friendly platform for the user to electronically sign the generated output documents. In various embodiments, this may involve, for example, integrating with e-signature service providers or implementing built-in e-signature functionality within the system's user interface. Users are guided through the e-signing process, which typically involves reviewing the documents, affixing their electronic signatures, and confirming their acceptance of the terms and conditions outlined therein.

In some embodiments, to ensure the validity and integrity of the e-signatures, the system implements security measures such as, e.g., encryption, authentication, and audit trails. These measures safeguard the integrity of the signing process, protect the confidentiality of the signed documents, and provide a verifiable record of the signing events for compliance and audit purposes.

In some embodiments, once the documents are electronically signed, the system securely stores the signed copies in a centralized repository, ensuring easy access and retrieval as needed. Additionally, the system may automatically notify relevant stakeholders, such as lenders or loan officers, of the completed e-signatures, triggering subsequent steps in the loan processing workflow.

By facilitating e-signatures, the system eliminates the need for traditional paper-based signatures, streamlining the document execution process, reducing paperwork, and accelerating the overall loan approval timeline. This enhances the convenience and efficiency of the mortgage loan application process for all parties involved, leading to a smoother and more seamless borrower experience.

In some embodiments, the system integrates the virtual processor with one or more external e-signature platforms. By integrating with external e-signature platforms, the virtual processor provides users, including mortgage brokers and applicants, with a mechanism for electronically signing the required documentation. One or more of these external e-signature platforms may offer features and capabilities for securely capturing, authenticating, and validating electronic signatures in compliance with legal and regulatory requirements.

In some embodiments, the system receives information that the user wishes to switch to one or more additional lenders. The system then receives additional non-standardized input data including information required by the one or more additional lenders. The system standardizes the additional non-standardized input data into the standardized format; updates the assigned tasks to one or more new tasks associated with the one or more additional lenders; and generates new output documents in new formats associated with the one or more additional lenders. In some embodiments, the user expresses a desire to switch to one or more additional lenders. This feature enhances the flexibility of the system by allowing users to explore alternative lending options or pursue better terms and conditions offered by different lenders. Upon receiving such information, the system initiates a series of steps to facilitate the transition smoothly and efficiently. In some embodiments, these steps are performed in real-time or substantially real-time. First, the system receives information indicating the intent to switch to additional lenders, either from the mortgage broker or the applicant directly. This notification triggers the subsequent stages of the process, enabling the system to prepare for the inclusion of new lenders into the application workflow. Subsequently, the system receives additional non-standardized input data related to the requirements of the newly selected lenders. Upon receipt of the additional input data, the system standardizes this information into the established standardized format, ensuring consistency and compatibility with the existing data structure. In some embodiments, this standardization process involves mapping the new lender requirements to the predefined schema. Following the standardization of the additional input data, the system updates the assigned tasks to accommodate the requirements of the newly selected lenders. This may involve modifying existing tasks, adding new tasks specific to the additional lenders, or adjusting task priorities based on the updated application context. The system dynamically adapts the task assignment logic in real time or substantially real time to ensure that all relevant actions are aligned with the preferences and expectations of the newly chosen lenders. Finally, the system generates new output documents in formats tailored to the requirements of the additional lenders. Leveraging the standardized input data and updated task assignments, the system dynamically assembles the necessary documentation to meet the specific formatting and content guidelines prescribed by each newly selected lender.

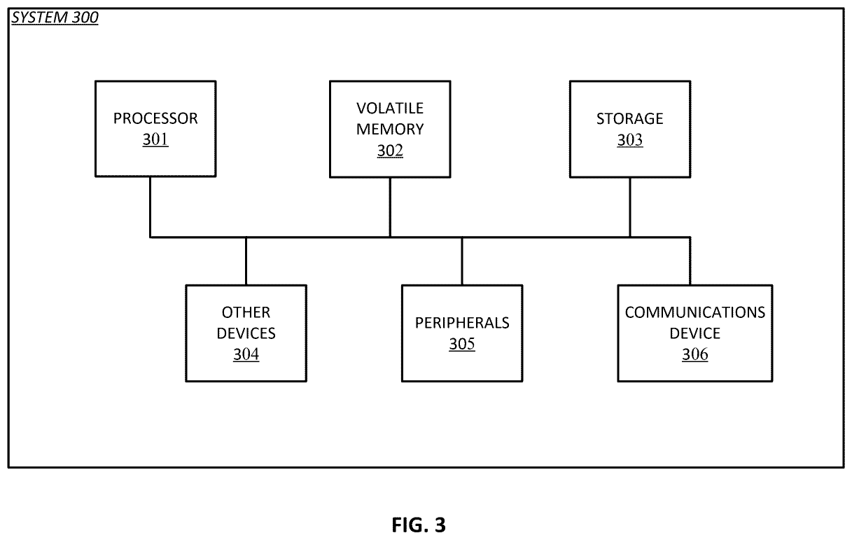

FIG. 3 is a diagram illustrating an exemplary computer that may perform processing in some embodiments. Exemplary computer 300 may perform operations consistent with some embodiments. The architecture of computer 300 is exemplary. Computers can be implemented in a variety of other ways. A wide variety of computers can be used in accordance with the embodiments herein.

Processor 301 may perform computing functions such as running computer programs. The volatile memory 302 may provide temporary storage of data for the processor 301. RAM is one kind of volatile memory. Volatile memory typically requires power to maintain its stored information. Storage 303 provides computer storage for data, instructions, and/or arbitrary information. Non-volatile memory, which can preserve data even when not powered and including disks and flash memory, is an example of storage. Storage 303 may be organized as a file system, database, or in other ways. Data, instructions, and information may be loaded from storage 303 into volatile memory 302 for processing by the processor 301.

The computer 300 may include peripherals 305. Peripherals 305 may include input peripherals such as a keyboard, mouse, trackball, video camera, microphone, and other input devices. Peripherals 305 may also include output devices such as a display. Peripherals 305 may include removable media devices such as CD-R and DVD-R recorders/players. Communications device 306 may connect the computer 100 to an external medium. For example, communications device 306 may take the form of a network adapter that provides communications to a network. A computer 300 may also include a variety of other devices 304. The various components of the computer 300 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure is, accordingly, to be regarded in an illustrative sense rather than a restrictive sense.

What is claimed is:

1. A method for processing mortgage loan applications using a virtual processor, comprising:
receiving a set of non-standardized input data comprising information required by one or more lenders associated with a user, wherein the user comprises one of a mortgage broker, applicant, or correspondent lender;
cataloging one or more requirements of each lender based on the non-standardized input data;
standardizing the received non-standardized input data into a standardized format;
receiving preliminary information from the user;
processing the received preliminary information to determine additional requirements of the lender based on a plurality of variables derived from the preliminary information;
assigning one or more tasks to the user based on the requirements of the lenders;
receiving, in response to assigning the one or more tasks, information related to the user;
generating, using at least the information related to the user, output documents in specific formats required by the one or more selected lenders using the standardized input data; and
facilitating the e-signature of the generated output documents by the user.

2. The method of claim 1, further comprising:
receiving information that the user wishes to switch to one or more additional lenders;
receiving additional non-standardized input data comprising information required by the one or more additional lenders;
standardizing the additional non-standardized input data into the standardized format;
updating the assigned tasks to one or more new tasks associated with the one or more additional lenders; and
generating new output documents in new formats associated with the one or more additional lenders.

3. The method of claim 2, wherein the step of updating the assigned tasks further comprises:
notifying the user of any new tasks or information required due to the switch to the one or more additional lenders.

4. The method of claim 1, further comprising:
storing the cataloged requirements of each lender in a database accessible by the virtual processor.

5. The method of claim 1, wherein the step of assigning tasks further comprises:
dynamically updating the list of assigned tasks in response to one or more changes in the requirements of one of the lenders.

6. The method of claim 1, wherein the step of standardizing the received input data further comprises:
validating the information related to the user against a set of predefined rules to ensure completeness and accuracy.

7. The method of claim 1, wherein the step of generating output documents further comprises:
converting the standardized input data into multiple document formats required by different lenders simultaneously.

8. The method of claim 1, further comprising:
integrating the virtual processor with one or more external e-signature platforms.

9. The method of claim 1, wherein the information related to the user comprises at least one of:
personal information, financial information, property information, and loan details.

10. The method of claim 1, further comprising:
providing a user interface for the user to input the information related to the user.

11. The method of claim 10, wherein the user interface further enables the user to select the one or more lenders.

12. A system comprising:
one or more processors; and
memory storing instructions that, when executed by the one or more processors, cause the system to perform operations comprising:
receiving a set of non-standardized input data comprising information required by one or more lenders associated with a user, wherein the user comprises one of a mortgage broker, applicant, or correspondent lender;
cataloging one or more requirements of each lender based on the non-standardized input data;
standardizing the received non-standardized input data into a standardized format;
receiving preliminary information from the user;
processing the received preliminary information to determine additional requirements of the lender based on a plurality of variables derived from the preliminary information;
assigning one or more tasks to the user based on the requirements of the lenders;
receiving, in response to assigning the one or more tasks, information related to the user;
generating, using at least the information related to the user, output documents in specific formats required by the one or more selected lenders using the standardized input data; and
facilitating the e-signature of the generated output documents by the user.

13. The system of claim 12, wherein the cataloged requirements of each lender are updated in real-time based on changes in the lenders' submission guidelines.

14. The system of claim 12, wherein the standardized format comprises a standardized input form to collect information from the user needed for any of the one or more lenders.

15. The system of claim 12, wherein the instructions further cause the system to perform operations comprising:
receiving information that the user wishes to switch to one or more additional lenders;
receiving additional non-standardized input data comprising information required by the one or more additional lenders;
standardizing the additional non-standardized input data into the standardized format;
updating the assigned tasks to one or more new tasks associated with the one or more additional lenders; and
generating new output documents in new formats associated with the one or more additional lenders.

16. The system of claim 12, wherein the step of updating the assigned tasks further comprises:
notifying the user of any new tasks or information required due to the switch to the one or more additional lenders.

17. The system of claim 12, wherein the step of generating output documents further comprises:
converting the standardized input data into multiple document formats required by different lenders simultaneously.

18. The system of claim 12, wherein the information related to the user comprises at least one of:
personal information, financial information, property information, and loan details.

19. The system of claim 12, further comprising:
providing a user interface for the user to input the information related to the user.

20. A non-transitory computer-readable medium containing instructions comprising:
receiving a set of non-standardized input data comprising information required by one or more lenders associated with a user, wherein the user comprises one of a mortgage broker, applicant, or correspondent lender;
cataloging one or more requirements of each lender based on the non-standardized input data;
standardizing the received non-standardized input data into a standardized format;
receiving preliminary information from the user;
processing the received preliminary information to determine additional requirements of the lender based on a plurality of variables derived from the preliminary information;
assigning one or more tasks to the user based on the requirements of the lenders;
receiving, in response to assigning the one or more tasks, information related to the user;
generating, using at least the information related to the user, output documents in specific formats required by the one or more selected lenders using the standardized input data; and
facilitating the e-signature of the generated output documents by the user.
